(19) United States
(12) Patent Application Publication
(10) Pub. No.: US 2006/0263096 A1
(43) Pub. Date: Nov. 23, 2006

(54) Multi-channel transmission of quantum information

(76) Inventors: Mihaela Dinu, Freehold, NJ (US); Christophe J. Dorrer, Matawan, NJ (US); Clinton Randy Giles, Whippany, NJ (US); Inuk Kang, Eatontown, NJ (US); Dan Mark Marom, Howell, NJ (US)

Correspondence Address: MENDELSOHN & ASSOCIATES, P.C., 1500 JOHN F. KENNEDY BLVD., SUITE 405, PHILADELPHIA, PA, 19102, US

(21) Appl. No.: 11/210,973

(22) Filed: Aug. 24, 2005

Related U.S. Application Data
(60) Provisional application No. 60/681,726, filed on May 17, 2005.

(51) Int. Cl. H04B 10/04

(52) U.S. Cl. 398/187

(57) ABSTRACT

A communication system adapted to use wavelength (frequency) division multiplexing for quantum-key distribution (QKD). In one embodiment, a communication system of the invention has a transmitter coupled to a receiver via a transmission link. The transmitter has (i) a first optical-frequency comb source (OFCS) adapted to generate a first plurality of uniformly spaced frequency components and (ii) a first multi-channel optical modulator adapted to independently modulate each component of the first plurality to produce a quantum-information (QI) signal applied to the transmission link. The receiver has (i) a second OFCS adapted to generate a second plurality of uniformly spaced frequency components and (ii) a second multi-channel optical modulator adapted to independently modulate each component of the second plurality to produce a local-oscillator (LO) signal. Each of the first and second optical-frequency comb sources is referenced to a frequency standard such that the frequency components generated by these comb sources have substantially the same frequencies. The receiver employs a multi-channel homodyne detector adapted to process interference signals produced by combining the LO signal with the QI signal to ascertain quantum information carried by the QI signal.

### CROSS-REFERENCE TO RELATED APPLICATIONS

This application claims priority from U.S. Provisional Patent Application No. 60/681,726 filed May 17, 2005, and entitled “Quantum Key Distribution.” The subject matter of this application is related to that of U.S. patent application Ser. No. ______, filed on the same date as the present application, and entitled “Phase-Locking in a Multi-Channel Quantum Communication System,” which is incorporated herein by reference in its entirety.

### BACKGROUND OF THE INVENTION

1. Field of the Invention

The present invention relates to optical communication equipment and, more specifically, to equipment for transmission of encrypted data using quantum cryptography.

2. Description of the Related Art

Cryptography is often used to exchange messages between two or more nodes (users, stations) in enhanced or even perfect privacy. A typical cryptographic method employs a publicly announced encrypting/decrypting algorithm, with the confidentiality of transmitted information provided by a secret key used in conjunction with that algorithm. Usually, a secret key is a randomly chosen, sufficiently long sequence of bits. For example, in a symmetric ciphering scheme, the transmitting station encrypts information using the secret key and sends the encrypted data over a public channel to the receiving station. The receiving station then uses the same key to undo the encryption and recover the original information.

It is well known that the longer the key, the more secure the system. For example, one widely used encryption system, the Data Encryption Standard (DES), has a key length of 56 bits. No method substantially more efficient than trying all 2⁵⁶ possible values of the key is known for breaking the DES. However, it is still possible that, if an eavesdropper has substantial computational power, the DES can be defeated. Therefore, to achieve higher security, a one-time pad (i.e., a key that is as long as the transmitted message) can be used. Although a communication system employing one-time pads is theoretically secure against attacks based on sheer computational power, nevertheless, such a system has to deal with what is known as the key-distribution problem, i.e., the problem of securely furnishing keys to the transmitting/receiving stations.

With conventional (classical) key transmission methods, which can be subject to passive monitoring by an eavesdropper, it is relatively difficult to transmit a certifiably secret key, and cumbersome physical security measures are usually required. However, secure key distribution is possible with quantum techniques. More specifically, in quantum cryptography, a secret key is transmitted through a special quantum channel whose security is based on the principles of quantum mechanics. More specifically, it is known that any measurement of a suitably chosen quantum system inevitably modifies the quantum state of that system. Therefore, when an eavesdropper attempts to get information out of the quantum channel by performing a measurement, the fact that the measurement has been performed can be detected by legitimate users, who will then discard all compromised keys.

In practice, a quantum channel can be established using, e.g., (i) a train of single photons propagating through an optical fiber, with key bits encoded by the photon's polarization or phase, or (ii) a train of coherent optical pulses, each containing a small number (e.g., less than a few hundred) of photons, with key bits encoded by quadrature values of selected variables characterizing each pulse. More details on the establishment and use of representative quantum channels can be found, e.g., in a review article by N. Gisin, G. Ribordy, W. Tittel, and H. Zbinden, entitled “Quantum Cryptography,” published in Reviews of Modern Physics, 2002, vol. 74, pp. 145-195, the teachings of which are incorporated herein by reference.

Although some progress has been made in developing equipment for quantum channels, this equipment is still not up to the performance targets, e.g., in quantum-key distribution (QKD) rate and transmission distance. For example, a current commercially available QKD system offers a QKD rate of about 1.5 kb/s over a single-mode optical fiber having a length of about 25 km. For comparison, a representative classical communication system offers a data transmission rate of about 10 Gb/s over an optical fiber having a length of about 1000 km. Given these parameters for the QKD and classical systems, one finds that significant improvements in QKD rate and/or transmission distance are desirable.

### SUMMARY OF THE INVENTION

Problems in the prior art are addressed, in accordance with the principles of the present invention, by a communication system adapted to use wavelength (frequency) division multiplexing for quantum-key distribution (QKD). In one embodiment, a communication system of the invention has a transmitter coupled to a receiver via a transmission link. The transmitter has (i) a first optical-frequency comb source (OFCS) adapted to generate a first plurality of uniformly spaced frequency components and (ii) a first multi-channel optical modulator adapted to independently modulate each component of the first plurality to produce a quantum-information (QI) signal applied to the transmission link. The receiver has (i) a second OFCS adapted to generate a second plurality of uniformly spaced frequency components and (ii) a second multi-channel optical modulator adapted to independently modulate each component of the second plurality to produce a local-oscillator (LO) signal. Each of the first and second optical-frequency comb sources is independently referenced to a frequency standard (e.g., a Cs atomic clock) such that the frequency components generated by these comb sources have substantially the same frequencies. The receiver employs a multi-channel homodyne detector adapted to process interference signals produced by combining the LO signal with the QI signal to ascertain quantum information carried by the QI signal. Advantageously, a communication system of the invention can be configured to have an aggregate (summed over all channels) QKD rate comparable with Ethernet bit rates.

According to one embodiment, the present invention is a communication system for transmission of quantum information, comprising a transmitter coupled to a receiver via a transmission link, wherein: the transmitter comprises a first optical source coupled to a first optical modulator, wherein the first optical modulator is adapted to modulate light generated by the first optical source to produce a quantum-information (QI) signal applied to the transmission link; and the receiver comprises a second optical source coupled to a second optical modulator, wherein: the second optical modulator is adapted to modulate light generated by the second optical source to produce a local-oscillator (LO) signal; and the LO signal is combined with the QI signal received via the transmission link to ascertain quantum information carried by the QI signal.

According to another embodiment, the present invention is a transmitter in a communication system for transmission of quantum information, the transmitter comprising a first optical source coupled to a first optical modulator, wherein the first optical modulator is adapted to modulate light generated by the first optical source to produce a quantum-information (QI) signal, wherein: the communication system comprises a receiver coupled to the transmitter via a transmission link; the QI signal is applied to the transmission link; and the receiver comprises a second optical source coupled to a second optical modulator, wherein: the second optical modulator is adapted to modulate light generated by the second optical source to produce a local-oscillator (LO) signal; and the LO signal is combined with the QI signal received via the transmission link to ascertain quantum information carried by the QI signal.

According to yet another embodiment, the present invention is a receiver in a communication system for transmission of quantum information, the receiver comprising a second optical source coupled to a second optical modulator, wherein: the second optical modulator is adapted to modulate light generated by the second optical source to produce a local-oscillator (LO) signal; the communication system comprises a transmitter coupled to the receiver via a transmission link; the transmitter comprises a first optical source coupled to a first optical modulator, wherein the first optical modulator is adapted to modulate light generated by the first optical source to produce a quantum-information (QI) signal applied to the transmission link; and the LO signal is combined with the QI signal received via the transmission link by the receiver to ascertain quantum information carried by the QI signal.

According to yet another embodiment, the present invention is a method of transmitting quantum information, comprising: modulating light generated by a first optical source to produce a quantum-information (QI) signal at a transmitter of a communication system; directing the QI signal via a transmission link to a receiver of said communication system; modulating light generated by a second optical source to produce a local-oscillator (LO) signal at the receiver; and combining the LO signal with the QI signal received via the transmission link at the receiver to ascertain quantum information carried by the QI signal.

### BRIEF DESCRIPTION OF THE DRAWINGS

Other aspects, features, and benefits of the present invention will become more fully apparent from the following detailed description, the appended claims, and the accompanying drawings in which:

FIG. 1 schematically shows a prior-art quantum-key distribution (QKD) system;

FIGS. 2A-B graphically illustrate a representative phase-modulation format and the corresponding homodyne detection statistics, respectively, for the QKD system shown in FIG. 1;

FIG. 3 schematically shows a QKD system according to one embodiment of the invention;

FIGS. 4A-B graphically illustrate representative characteristics of an optical-frequency comb source (OFCS) that can be used in the QKD system of FIG. 3 according to one embodiment of the invention; and

FIG. 5 graphically shows a method of measuring an offset-frequency for the OFCS illustrated in FIG. 4 according to one embodiment of the invention.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

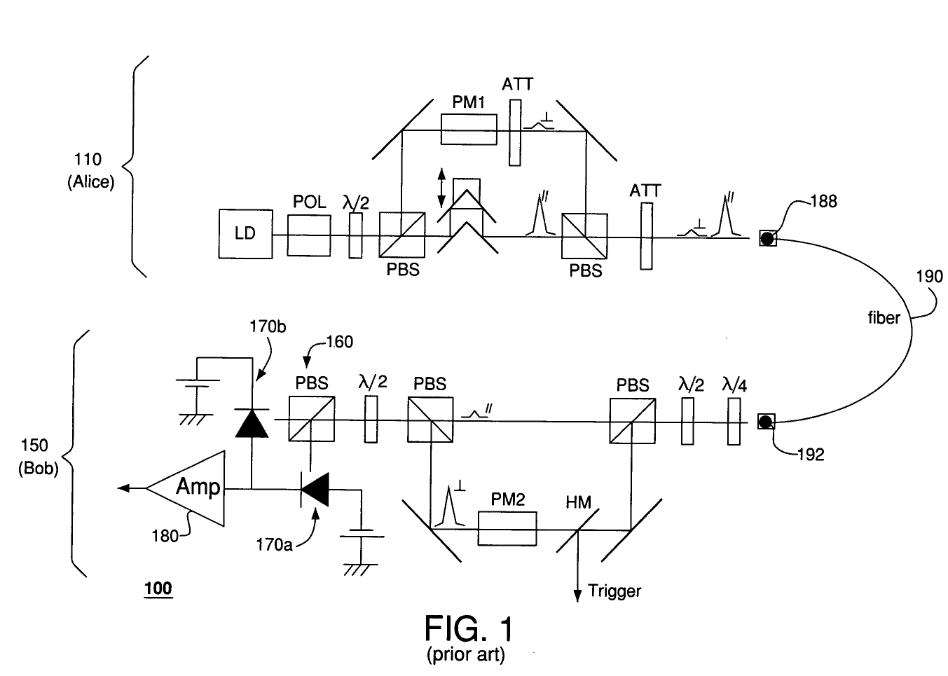

FIG. 1 schematically shows a prior-art quantum-key distribution (QKD) system 100. More specifically, system 100 has a transmitter 110 (Alice) and a receiver 150 (Bob) coupled via an optical fiber 190. System 100 is designed to transmit quantum information using phase modulation and homodyne detection. For each quantum bit, transmitter 110 generates two correlated optical pulses (i.e., a relatively weak pulse and a relatively strong pulse) by appropriately splitting an output signal produced by a laser diode (LD). Each weak pulse has a quantum level of intensity suitable for QKD (e.g., a few photons per pulse) and is subjected to phase modulation by a phase modulator PM1. This phase modulation of the weak (quantum) pulse serves two purposes: (1) selection of Alice's basis set for the corresponding quantum bit and (2) encoding of the quantum-bit value. Each strong pulse has a classical level of intensity (e.g., about 10⁶ photons per pulse) and is not phase-modulated in transmitter 110. The pulses are time-delayed with respect to one another, e.g., as graphically indicated at an input coupler 188 of fiber 190 in FIG. 1, with the weak (quantum) pulse trailing the strong (classical) pulse, and are coupled into the fiber.

After emerging at an output coupler 192 of fiber 190, the pulses enter receiver 150, where the time delay between the pulses is reversed and the pulses become temporally aligned. The strong (classical) pulse is subjected to phase modulation by a phase modulator PM2 in receiver 150, with the phase modulation serving the purpose of selecting Bob's basis set for the measurement of the quantum-bit value carried by the corresponding weak (quantum) pulse. Note that the weak (quantum) pulse is not phase-modulated in receiver 150. The pulses are spatially combined at a beam splitter 160, which then splits the resulting optical signal into two (interference) sub-signals and directs each of the sub-signals to a corresponding one of photo-detectors 170a-b. Each of photo-detectors 170a-b measures intensity of the received sub-signal and applies the resulting electrical output to a differential amplifier 180. Amplifier 180 takes a difference of the two outputs, amplifies it, and directs the amplified signal for further processing to a signal processor (not shown).

Together, beam splitter 160, photo-detectors 170a-b, and amplifier 180 at receiver 150 implement a homodyne detection scheme. This scheme provides a quadrature measurement for the weak (quantum) pulse (quantum-information signal), from which measurement the quantum-bit value encoded on that pulse can be ascertained. Note that, in this measurement, the strong (classical) pulse acts as a local oscillator (LO). Description of additional hardware elements (e.g., a polarizer (POL), polarizing beam splitters (PBS), attenuators (ATT), a partial mirror (HM), and half- and quarter-wave plates) employed in system 100 and their respective functions can be found in a paper by T. Hirano, et al., Phys. Rev. A, vol. 68, p. 42331 (2003), the teachings of which are incorporated herein by reference.

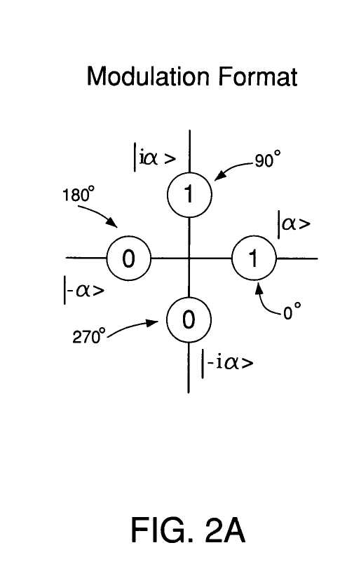

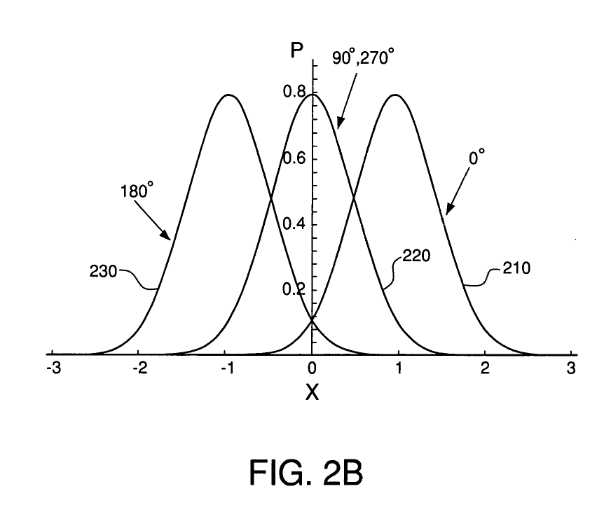

FIGS. 2A-B graphically illustrate a representative phase-modulation format and the corresponding homodyne detection statistics, respectively, for system 100. Referring to FIG. 2A, transmitter 110 (Alice) encodes quantum-bit values onto weak (quantum) pulses by randomly choosing a phase shift for a coherent state |α>from 0, 90, 180, and 270 degrees using phase modulator PM1 (FIG. 1), with the phase shifts of 0 and 90 degrees associated with binary “1” and the phase shifts of 180 and 270 degrees associated with binary “0”. Receiver 150 (Bob) randomly chooses a phase shift for phase modulator PM2 (FIG. 1) from 0 and 90 degrees and applies these phase shifts to strong (classical) pulses. As a result, for each pair of (quantum and classical) pulses, system 100 produces a relative phase shift φ=φ_{A}−φ_{B}, where φ_{A} and φ_{B} are Alice's and Bob's phase shifts, respectively.

In noiseless classical pulsed homodyne detection (with the term “classical” meaning that both pulses have classical levels of intensity), an amplifier analogous to amplifier 180 of system 100 produces a deterministic output proportional to 2E_{S}E_{LO} cos φ, where E_{S} and E_{LO} are the electric fields of the information signal and local oscillator, respectively. Thus, for φ=0 and 180 degrees, the amplifier produces an output having a normalized value of 1 and −1, respectively. Similarly, for φ=90 or 270 degrees, the amplifier produces an output having a normalized value of zero.

Due to the fact that, in system 100, the information signal is represented by a weak (quantum) pulse (while the strong (classical) pulse acts as the local oscillator signal), the output of amplifier 180 is not deterministic even in the absence of noise, but rather, is affected by quantum fluctuations that can be described by appropriate probability distribution functions. FIG. 2B graphically shows representative probability distribution functions that describe the output of amplifier 180, when the average number of photons for the weak (quantum) pulses is 1 photon per pulse. More specifically, in FIG. 2B, the horizontal axis, X, represents a normalized output of amplifier 180, while the vertical axis, P, represents the probability of that output. Curve 210 is a probability distribution function corresponding to φ=0°; curve 220 is a probability distribution function corresponding to φ=90 and 270°; and curve 230 is a probability distribution function corresponding to φ=180°. Each probability distribution function has a Gaussian shape and is centered at the corresponding classical normalized value.

Note that curve 220 describes the probability distribution functions for both φ=90 and 270°. For these relative phase shifts, Bob is unable to ascertain the quantum-bit values encoded by Alice onto the quantum-information signal, because Bob has selected an incorrect basis set, i.e., different from that selected by Alice. However, Bob can differentiate φ=0° from φ=180° because curves 210 and 230 are different. In that case, both Alice and Bob have selected the same basis set.

Representative signal processing implemented by Bob may include setting up two threshold values, X₊ and X₋, where X₋≦X₊. If the normalized output, Xₙ, of amplifier 180 is greater than X₊, then Bob judges φ=0°. If Xₙ is smaller than X₋, then Bob judges φ=180°. If Xₙ is between X₊ and X₋, then Bob gets an inconclusive result and abandons the judgment. Note that, because curves 210 and 230 have an area of overlap, Bob's judgment is not always true and there exists an intrinsic error probability. This intrinsic error probability reflects the fact that there is a non-zero probability that (i) the true φ value is 180° when Bob makes a judgment that φ=0° and (ii) the true φ value is 0° when Bob makes a judgment that φ=180°.

After an appropriate number of pulses have been transmitted from Alice to Bob, Bob tells Alice, via an authenticated public channel established, e.g., over a conventional telephone or computer network, his basis-set choices, and Alice tells Bob which choices provided the correct basis set for ascertaining the quantum-bit values. Bob then discards the measurement results corresponding to the incorrect basis sets and interprets the remaining measurement results in accordance with the modulation format of FIG. 2A. Finally, Alice and Bob carry out error correction and privacy amplification procedures with the interpreted data to distill a secure quantum key. Additional information on representative error correction and privacy amplification procedures can be found, e.g., in (1) F. Grosshans and P. Grangier, Phys. Rev. Letters, 2002, vol. 88, N. 5, p. 057902; (2) F. Grosshans and P. Grangier, arXiv:quant-ph/0204127 v1, 22 Apr. 2002; and (3) M. A. Nielsen and I. L. Chuang, “Quantum Computation and Quantum Information,” Cambridge University Press (2000), pp. 582-603, the teachings of all of which are incorporated herein by reference.

Referring back to FIG. 1, one important feature of system 100 is that the local oscillator signal (classical pulse) is transported from transmitter 110 along fiber 190 to receiver 150 together with the information signal (quantum pulse). In classical communications, a known alternative to transporting the LO signal from the transmitter to the receiver is to provide a tunable light source at the receiver together with a phase-lock loop (PLL) configured to lock the frequency and phase of the optical signal generated by that light source to those of the information signal. The PLL typically functions by (i) simultaneously measuring the beat frequency and phase offset between the communication (information) signal and the signal generated by the tunable light source and (ii) providing an appropriate feedback to the tunable light source, which forces the light source to keep these parameters within specified bounds. However, in the quantum limit applicable to quantum communications in general and system 100 in particular, a simultaneous measurement of frequency and phase requires a measurement of two non-commuting quadratures (variables), which is prohibited by the fundamental principles of quantum mechanics. As an illustration, a beat-frequency measurement is akin to a measurement of an energy difference (ΔE), and a phase-offset measurement is akin to a measurement of a time interval (Δt), which measurements are governed by the Heisenberg uncertainty relationship ΔEΔt≧h-, where h- is the Planck constant. One practical effect of this fundamental uncertainty relationship on system 100 is that, in the quantum limit, simultaneous locking, with suitable accuracy, of the LO frequency and phase is not possible at receiver 150. Due to this fundamental limitation, system 100 cannot be implemented with a receiver having an independent (second) light source driven by a conventional PLL. As already explained above, system 100 is instead configured to transport the LO signal from transmitter 110 to receiver 150, with the transported LO signal being phase- and frequency-locked to the quantum-information signal by virtue of originating from the same light source (LD in FIG. 1).

Furthermore, the fact that the local oscillator signal is transported from transmitter 110 to receiver 150 makes system 100 substantially incompatible with multi-channel QKD transmission. For example, suppose that system 100 supports two QKD channels operating at two different wavelengths (frequencies). Then, fiber 190 has to transport strong (classical) LO pulses corresponding to each of those channels. To avoid nonlinear optical interactions in fiber 190, e.g., between LO pulses corresponding to different QKD channels, these pulses have to be temporally separated at input coupler 188. However, due to the fact that the speed of light in fiber 190 depends on wavelength, pulses corresponding to different channels propagate along the fiber at different speeds. As a result, even if the pulses are initially temporally separated, due to a relatively large length (e.g., several kilometers or more) of fiber 190, the faster moving pulse may eventually catch up with a slower moving pulse, which it initially trailed in the fiber. The overlapped pulses then nonlinearly interact as they propagate along fiber 190, e.g., via four-wave mixing and cross-phase modulation, with the interaction giving rise to a detrimental inter-channel crosstalk. Disadvantageously, this crosstalk may significantly increase the error rate for system 100, if not completely destroy the system's QKD capability.

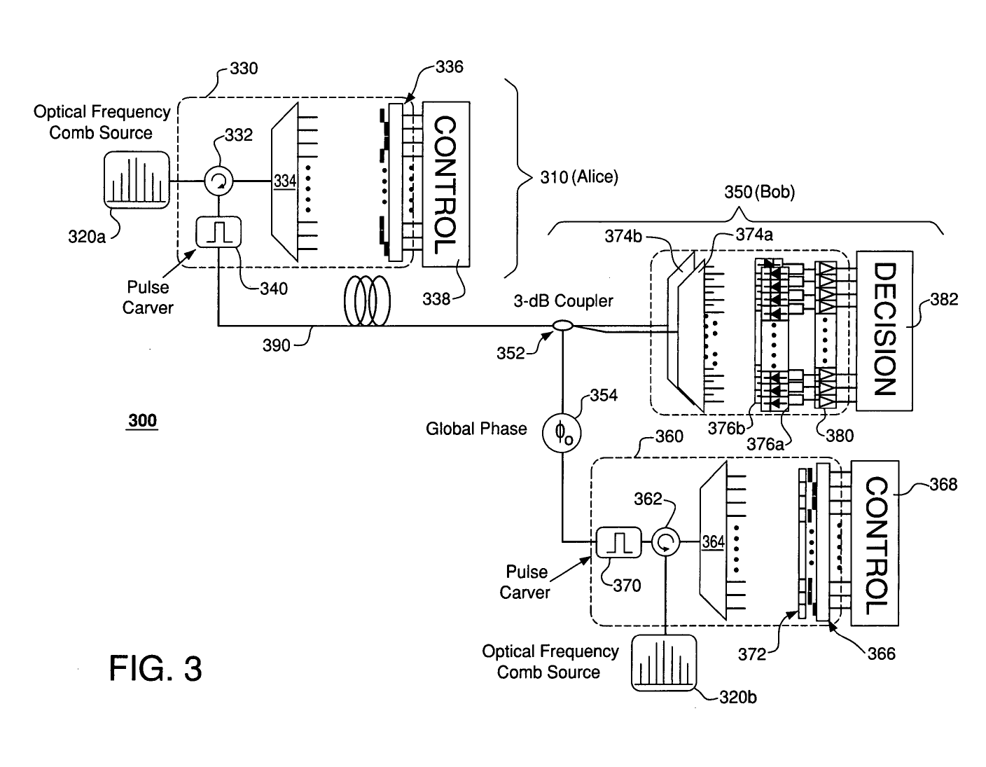

FIG. 3 schematically shows a QKD system 300 according to one embodiment of the invention. More specifically, system 300 has a transmitter 310 (Alice) and a receiver 350 (Bob) coupled via an optical fiber 390. In one embodiment, system 300 is adapted to transmit quantum information using phase modulation and homodyne detection analogous to those used in system 100 of FIG. 1. However, one difference between systems 100 and 300 is that the former uses the same light source (LD at transmitter 110) to generate both the quantum-information and LO signals, while the latter is designed to employ two separate light sources, i.e., optical-frequency comb sources 320a-b located at transmitter 310 and receiver 350, respectively. More specifically, optical-frequency comb source (OFCS) 320a is used at transmitter 310 to generate one or more quantum-information signals, which are then frequency multiplexed and coupled into fiber 390. OFCS 320b is used at receiver 350 to generate one or more local-oscillator signals, which are then used to implement homodyne detection of the corresponding quantum-information signals received by the receiver via fiber 390 from transmitter 310. As a result, unlike system 100, system 300 does not transport a local oscillator signal from Alice to Bob.

System 300 is able to circumvent the (above-explained) fundamental limitations of system 100 because each of optical-frequency comb sources 320a-b is able to generate optical frequencies with such accuracy that conventional frequency locking of OFCS 320b to OFCS 320a is no longer required. For example, in one embodiment, OFCS 320 provides a frequency comb, in which each frequency mode has (i) a width of about 10 kHz or narrower and (ii) a center frequency located within about 100 Hz or less from a designated frequency. Advantageously, these characteristics of OFCS 320 enable system 300 to perform homodyne detection of quantum-information signal(s) at receiver 350 without transporting LO signal(s) from transmitter 310 to the receiver. Furthermore, the fact that the local oscillator is not transported from transmitter 310 to receiver 350 makes system 300 amenable to multi-channel QKD transmission. More specifically, due to a relatively small distance (e.g., less than about 1 m) along which relatively strong LO signals originating at OFCS 320b in receiver 350 are transported in the same optical fiber, nonlinear optical interactions between those signals in that fiber do not significantly increase the error rate for system 300 compared to that in a single-channel QKD configuration of that system.

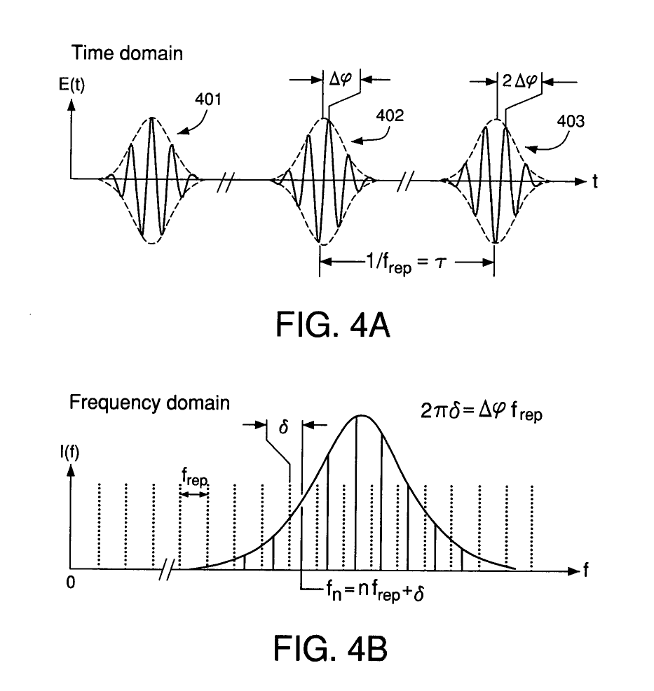

FIGS. 4A-B graphically illustrate representative characteristics of OFCS 320 according to one embodiment of the invention. More specifically, in the embodiment illustrated by FIG. 4, OFCS 320 is a mode-locked laser with a controlled carrier-envelope offset (CEO) phase.

FIG. 4A shows a pulse train generated by such a representative mode-locked laser with CEO phase control. More specifically, three consecutive pulses in the train are shown, with the solid lines representing the electric-field carrier wave and the dashed lines representing the corresponding pulse envelopes. The envelope peak-to-peak separation between the pulses (τ) is 1/fᵣₑₚ, where fᵣₑₚ is the pulse repetition rate. As can be seen in FIG. 4A, the relative phase between the peak of the pulse envelope and the underlying electric-field carrier wave is not constant and varies from pulse to pulse. For example, for pulse 401, the peak of the pulse envelope is aligned with a peak of the electric-field carrier, i.e., the relative phase is zero. However, for pulse 402, the relative phase between the peak of the pulse envelope and the nearest peak of the electric-field carrier has changed to become Δφ; and, for pulse 403, this relative phase has further incremented by Δφ to become 2Δφ. This pulse-to-pulse phase evolution is primarily due to the fact that the group and phase velocities differ inside the mode-locked laser cavity. However, advantageously, modem femtosecond-laser techniques enable effective control and stabilization of the CEO-phase increment (Δφ) to produce predictable and reproducible phase evolution.

FIG. 4B shows a frequency spectrum corresponding to the pulse train of FIG. 4A. More specifically, the vertical solid lines represent modes of the frequency comb corresponding to the pulse train of FIG. 4A, with the bell-shaped curve indicating the frequency-comb envelope. Note that, in the frequency domain, the output of a CEO-phase-controlled mode-locked laser is substantially equivalent to the combined output of a collection of correlated continuous-wave (CW) lasers, each producing a corresponding frequency mode of the frequency comb. The vertical dotted lines in FIG. 4B show a frequency grid, nfᵣₑₚ, where n is a positive integer. As seen in FIG. 4B, the frequency comb generated by the CEO-phase-controlled mode-locked laser is not necessarily aligned with this frequency grid, but in general, is shifted with respect to the grid by an offset frequency, δ=Δφfᵣₑₚ/2π, with the individual frequencies (fₙ) in the frequency comb described by Eq. (1) as follows:
fₙ=nfᵣₑₚ+δ(1)
One consequence of the relationship given by Eq. (1) is that control of the phase increment (Δφ) provides effective means for controlling the absolute values of the optical frequencies in the frequency comb. Additional details on the characteristics of CEO-phase-controlled mode-locked lasers can be found, e.g., in D. J. Jones, et al., Science, vol. 288, p. 635 (2000), the teachings of which are incorporated herein by reference.

Other embodiments of the invention can use OFCS sources other than CEO-phase-controlled mode-locked lasers, even though the latter can offer the advantages of (i) self-referencing, i.e., the capability of assigning optical comb frequencies without locking to a particular physical optical transition, and (ii) relatively large bandwidth available for QKD due to the octave-spanning spectrum. For example, a mode-locked laser with one component in its frequency comb locked to a reference atomic transition is an acceptable OFCS. Similarly, a monochromatic laser locked to a reference atomic transition, with its output sinusoidally modulated by an optical modulator driven at a relatively high (e.g., radio) frequency, is another acceptable OFCS.

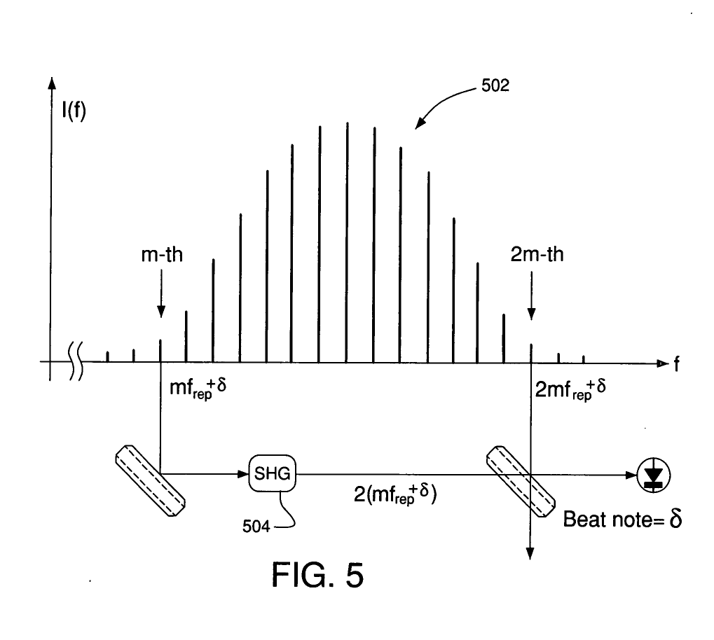

FIG. 5 graphically shows a method of measuring an offset frequency (δ) according to one embodiment of the invention. The method of FIG. 5 is generally applicable to an octave-spanning frequency comb and can be used, for example, to accurately reference and control the output of a corresponding CEO-phase-controlled mode-locked laser. More specifically, according to the method of FIG. 5, light corresponding to an m-th mode (where m is a positive integer) from the low-frequency side of an octave-spanning frequency comb 502 is frequency doubled using a second-harmonic-generating (SHG) element 504. The resulting second harmonic has a frequency of f_{SH}=2fₘ=2mfᵣₑₚ+2δ. The second harmonic is then interfered with the (2m)-th mode from the high-frequency side of frequency comb 502, which mode has a frequency of f₂ₘ=2mfᵣₑₚ+δ. The interference produces a signal (beat note) having a difference frequency f_{SH}−f₂ₘ=δ. Thus, the offset frequency for the CEO-phase-controlled mode-locked laser can be monitored by measuring the frequency of the beat note. The value of δ can be adjusted by configuring the laser to set the group and phase velocities in the laser cavity such that the frequency comb is appropriately positioned with respect to the frequency grid. In one embodiment, the method of FIG. 5 can be used to reference two or more frequency combs 502 generated by different optical-frequency comb sources to an atomic clock to establish, e.g., a frequency alignment accuracy of about 100 Hz or better for optical-frequency comb sources 320a-b in system 300. More details, on atomic-clock referencing of CEO-phase-controlled mode-locked lasers can be found, e.g., in R. Holzwarth, et al., IEEE J. Quant. Electron., vol. 37, p. 1493 (2001), the teachings of which are incorporated herein by reference.

Referring back to FIG. 3, in one embodiment, each of optical-frequency comb sources 320a-b comprises a CEO-phase-controlled mode-locked laser (not shown) referenced to a selected atomic-clock frequency, e.g., as described above. Transmitter 310 includes a multi-channel phase modulator 330 configured to have a plurality of channels corresponding to a set of frequencies from the frequency comb generated by OFCS 320a. Modulator 330 has (I) a variable multiplexer/de-multiplexer (MUX/DMUX) 334 configured to receive the output of OFCS 320a via an optical circulator 332 and (II) a phase shifter 336 optically coupled to the MUX/DMUX. One function of MUX/DMUX 334 is to de-multiplex the comb frequencies produced by OFCS 320a into separate beams and direct these beams to phase shifter 336. Another function of MUX/DMUX 334 is to receive the phase-shifted beams back from phase shifter 336, re-multiplex them, and apply the resulting signal to optical circulator 332.

In one embodiment, phase shifter 336 includes a MEMS array of movable mirrors, e.g., similar to that disclosed in U.S. Pat. No. 6,876,484, which is incorporated herein by reference in its entirety. More specifically, each mirror in the array can be independently translated based on a control signal provided by a controller 338 to introduce a desired phase shift for the corresponding beam received by the mirror from MUX/DMUX 334, with the phase shift being proportional to the mirror displacement with respect to a reference position. In a representative configuration, phase shifter 336 is adapted to introduce, for each beam, optical phase shifts corresponding to the modulation format of FIG. 2A. More specifically, based on control signals from controller 338, phase shifter 336 positions each mirror in the mirror array such that the resulting phase shift is substantially one of 0, 90, 180, and 270 degrees. For each time slot, the phase shift is randomly selected for each beam from these values to encode a corresponding bit value and is kept constant for the time-slot duration, with the phase shifts of 0 and 90 degrees associated with the binary “1” and the phase shifts of 180 and 270 degrees associated with the binary “0”. The selected phase shift determines Alice's basis set selection for the corresponding quantum bit.

Note that, in the round trip from optical circulator 332 to the mirror array of phase shifter 336 and back, optical signals corresponding to the comb frequencies go through MUX/DMUX 334 two times. Since MUX/DMUX 334 is a variable MUX/DMUX, it can be configured to attenuate each of the optical signals in the corresponding channel by a desired amount independent of the attenuation introduced in the other channels. As such, MUX/DMUX 334 can provide an additional function of equalizing the optical signals (e.g., transforming the initial bell-shaped frequency-comb envelope produced by OFCS 320a into a substantially flat shape) and attenuating the light intensity in each channel to a quantum level suitable for QKD transmission. Optical circulator 332 then directs the phase-shifted/attenuated signals received from MUX/DMUX 334 to a pulse carver 340, which shapes these signals into a pulse train and couples the result into fiber 390. Pulse carver 340 and phase shifter 336 are appropriately synchronized, e.g., such that the carved-pulse position corresponds to a midpoint of the corresponding time slot. In a representative configuration, the time-slot duration is about 100 ns and each carved pulse has a width of about 10 ps.

The pulse train produced by pulse carver 340 is a frequency (wavelength) multiplexed quantum-information signal having a plurality of components corresponding to the channels of phase modulator 330. The attenuation introduced in MUX/DMUX 334 is selected such that the number of photons per pulse per component is appropriate for the QKD protocol used in system 300. For example, for the (well-known in the art) BB84 and B92 protocols, the number of photons is about 1 photon per pulse per component. Alternatively, for a continuous-variable protocol, the number of photons is about several hundred photons per pulse per component.

Receiver 350 includes a multi-channel phase modulator 360 that is substantially analogous to multi-channel phase modulator 330 of transmitter 310. More specifically, phase modulator 360 has an optical circulator 362, a MUX/DMUX 364, a phase shifter 366, a controller 368, and a pulse carver 370, which are analogous to optical circulator 332, MUX/DMUX 334, phase shifter 336, controller 338, and pulse carver 340, respectively, of phase modulator 330. However, one difference between phase modulators 330 and 360 is that the latter additionally has a multi-channel polarization controller 372. One reason for having polarization controller 372 in phase modulator 360 is that the polarization of the quantum-information signal produced by transmitter 310 may change as the signal propagates in fiber 390. Polarization controller 372 serves to align the polarization of each LO component originating at OFCS 320b with that of the corresponding component of the received quantum-information signal.

In one configuration, to determine proper polarization settings for polarization controller 372, transmitter 310 sends a training signal having a known sequence of quantum bits for each channel. Receiver 350 then uses this training signal to adjust the polarization setting for each channel to properly align the polarization of the LO component with the corresponding quantum-information component. For example, receiver 350 measures quadrature variables of each pulse, while the phase of the LO signal is shifted by 90 degrees from pulse to pulse. If the known sequence of quantum bits has substantially identical pulses, the sum of the squares of the measured quadrature variables of successive pulses, \sqrt{Xᵢ²+Xᵢ₊₁²}, is proportional to the amplitude of the quantum signal whose polarization is parallel to that of the LO field. Each frequency component of the polarization controller 372 can be controlled to rotate the polarization of each frequency component of LO field to be aligned with that of the quantum signal of the corresponding frequency. Once the proper polarizations settings are determined, polarization controller 372 is configured to fix these settings for the duration of a QKD session. This procedure can be repeated as often as necessary to ensure good and proper polarization alignment.

Each LO component produced by OFCS 320b and phase modulator 360 has a classical level of intensity (e.g., 10⁶ photons per pulse carved by pulse carver 370). Depending on the optical power generated by OFCS 320b, amplification of certain or all comb frequencies may be required in phase modulator 360 (as opposed to attenuation in phase modulator 330). As such, phase modulator 360 may incorporate one or more optical amplifiers (not shown) and have MUX/DMUX 364 configured to introduce as little attenuation as possible.

When transmitter 310 uses the modulation format shown in FIG. 2A, phase shifter 366 in phase modulator 360 is configured to position each mirror in its mirror array such that the resulting phase shift is substantially one of 0 and 90 degrees. For each time slot, the phase shift is randomly selected for each channel from these two values to provide Bob's basis set selection for ascertaining the bit value carried by the corresponding component of the quantum-information signal in that time slot. As a result, phase modulator 360 outputs a multi-component LO signal suitable for implementing at receiver 350 a homodyne detection scheme substantially similar to that implemented in system 100, for each component of the quantum-information signal received from transmitter 310.

As already explained above, the high accuracy of optical frequency generation in optical frequency comb sources 320a-b makes it unnecessary for system 300 to perform frequency locking of the LO signal to the quantum-information signal. However, phase locking between these signals is still required to enable phase modulator 360 to accurately provide the desired phase shifts of 0 and 90 degrees for the components of the LO signal. The task of phase locking the LO signal to the quantum-information signal is carried out by a global-phase modulator 354 and phase shifter 366. For example, to phase-lock an LO component to the corresponding component of the quantum-information signal, transmitter 310 sends a training signal having a known sequence of quantum bits for each channel. Receiver 350 then uses this training signal to adjust the mirror positions in phase shifter 366 such that, for each signal component, the relative phase difference between the LO and quantum-information signals is, e.g., 90 degrees.

When system 300 switches from training-sequence transmission to QKD transmission, receiver 350 uses the mirror positions determined during the training sequence as reference positions with respect to which appropriate mirror displacements are generated to produce the phase shifts required for ascertaining the quantum bit values. Global-phase modulator 354 is an optional element that can help maintain the phase lock after the initial phase lock has been achieved with phase shifter 366. More specifically, since different comb frequencies are all correlated with one another, additional phase variations among the channels that might occur over time are typically also correlated and deterministic. Therefore, these additional phase variations can be compensated by configuring global-phase modulator 354 to introduce an additional (global) phase shift, common for all frequencies (channels).

The quantum-information signal received via fiber 390 from transmitter 310 and the LO signal produced by OFCS 320b and phase modulator 360 are applied to a 3-dB coupler 352, which combines these signals and then splits the result into two interference sub-signals. Each of the interference sub-signals is then directed to a corresponding one of de-multiplexers 374a-b, which de-multiplexes the interference sub-signal into individual spectral components. Each pair of the sub-signal components having the same frequency is then used to implement homodyne detection substantially similar to that implemented in receiver 150 of system 100 (FIG. 1). More specifically, receiver 350 has two arrays 376a-b of photo-detectors coupled to an array 380 of charge-sensitive amplifiers. Photo-detectors receiving the same frequency in arrays 376a-b are connected to the corresponding amplifier in array 380 via photo-detector terminals having opposite polarity. As a result, the amplifier effectively acts as a differential amplifier configured to amplify a signal difference for the photo-detectors. The amplified difference signal is applied for further processing to a signal processor 382.

In one configuration, processor 382 processes the difference signal corresponding to each frequency by interpreting that signal, e.g., in accordance with the thresholding method described above in reference to FIG. 2B. After an agreed-upon number of quantum-information transmission time slots, Bob tells Alice, via an authenticated public channel, his choices of the basis sets for each frequency, and Alice tells Bob which choices provided the correct basis sets for ascertaining the quantum-bit values. Bob then discards the measurement results corresponding to the incorrect basis sets and interprets the remaining measurement results in accordance with the modulation format of FIG. 2A. Finally, Alice and Bob carry out error correction and privacy amplification procedures to distill a secure quantum key from the interpreted data.

In one embodiment, system 300 is designed to have the following characteristics: (i) channel (frequency) spacing of about 10 GHz; (ii) a total of 256 channels, which corresponds to about 20-nm spectral bandwidth; (iii) modulation speed of about 10 MHz, which corresponds to a time-slot duration of about 100 ns; (iv) intensity of the quantum-information signal of about 1 pW/channel; and (v) intensity of the LO signal of about 1 mW/channel. When implemented with these parameters, system 300 supports a QKD rate of over 20 Mb/s, which is a significant improvement over that provided by prior-art QKD systems. In another embodiment, in which system 300 utilizes a full octave-spanning optical range (e.g., from 1000 to 2000 nm), with 10-GHz channel spacing, the aggregate QKD rate can reach about 1 Gb/s. Advantageously, this aggregate QKD rate can provide full cryptographic support for a communication system operating at modem Ethernet speeds.

While this invention has been described with reference to illustrative embodiments, this description is not intended to be construed in a limiting sense. For example, instead of having a variable MUX/DMUX 334, phase modulator 330 can be implemented with a regular MUX/DMUX and a separate multi-channel attenuator coupled to that MUX/DMUX. Alternatively or in addition, phase shifter 336 can be configured to attenuate signal components, e.g., by tilting the mirrors or changing their reflectivity and/or shape. Furthermore, a single MUX/DMUX (e.g., MUX/DMUX 334 or MUX/DMUX 364) configured to perform both multiplexing and de-multiplexing functions can be replaced by two separate elements, a MUX configured to perform a multiplexing function only and a DMUX configured to perform a de-multiplexing function only. Various components may be implemented as waveguide circuits or free-space optical elements. Alternatively or in addition, similar modifications can be applied to phase modulator 360. An optical modulator other than a MEMS-based modulator can be used, e.g., a modulator implemented with an array of individual lithium niobate modulator elements, InP waveguide modulator elements, or InP surface normal modulator elements. System 300 can be configured to operate using various QKD protocols, e.g., without limitation, a BB84 protocol, a B92 protocol, or a continuous-variable protocol. Although the invention has been described in reference to phase modulation, one skilled in the art will appreciate that the invention can also be implemented with amplitude modulation or simultaneous modulation of the phase and amplitude. QKD bandwidth resources accessible with optical-frequency comb sources can be flexibly and dynamically allocated to support several different transmitter-receiver arrangements, e.g., (i) one transmitter coupled to one receiver as shown in FIG. 3, (ii) one transmitter coupled to two or more receivers, with the receivers configured to use different subsets of the comb frequencies utilized by the transmitter, (iii) two or more transmitters coupled to a single receiver, with the transmitters configured to use different subsets of the comb frequencies utilized by the receiver, and (iv) multiple transmitters coupled to multiple receivers, with appropriate allocation of the comb frequencies among these transmitters and receivers. OFCS sources different from CEO-phase-controlled mode-locked lasers can be used. Furthermore, certain embodiments of the invention can be implemented with light sources, each adapted to produce a single frequency (wavelength), with that frequency appropriately referenced to a frequency standard. Various frequency standards (e.g., types of atomic clocks) can be used without departing from the scope and principles of the invention. Various modifications of the described embodiments, as well as other embodiments of the invention, which are apparent to persons skilled in the art to which the invention pertains are deemed to lie within the principle and scope of the invention as expressed in the following claims.

For the purposes of this specification, a MEMS device is a device having two or more parts adapted to move relative to one another, where the motion is based on any suitable interaction or combination of interactions, such as mechanical, thermal, electrical, magnetic, optical, and/or chemical interactions. MEMS devices are fabricated using micro- or smaller fabrication techniques (including nano-fabrication techniques) that may include, but are not necessarily limited to: (1) self-assembly techniques employing, e.g., self-assembling monolayers, chemical coatings having high affinity to a desired chemical substance, and production and saturation of dangling chemical bonds and (2) wafer/material processing techniques employing, e.g., lithography, chemical vapor deposition, patterning and selective etching of materials, and treating, shaping, plating, and texturing of surfaces. The scale/size of certain elements in a MEMS device may be such as to permit manifestation of quantum effects. Examples of MEMS devices include, without limitation, NEMS (nano-electromechanical systems) devices, MOEMS (micro-opto-electromechanical systems) devices, micromachines, microsystems, and devices produced using microsystems technology or microsystems integration.

Although the present invention has been described in the context of implementation as MEMS devices, the present invention can in theory be implemented at any scale, including scales larger than micro-scale.

Although the steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

What is claimed is:

1. A communication system for transmission of quantum information, comprising a transmitter coupled to a receiver via a transmission link, wherein:
the transmitter comprises a first optical source coupled to a first optical modulator, wherein the first optical modulator is adapted to modulate light generated by the first optical source to produce a quantum-information (QI) signal applied to the transmission link; and
the receiver comprises a second optical source coupled to a second optical modulator, wherein:
the second optical modulator is adapted to modulate light generated by the second optical source to produce a local-oscillator (LO) signal; and
the LO signal is combined with the QI signal received via the transmission link to ascertain quantum information carried by the QI signal.

2. The invention of claim 1, wherein the LO signal is not transmitted via the transmission link.

3. The invention of claim 1, wherein each of the first and second optical sources is referenced to a frequency standard.

4. The invention of claim 1, wherein the receiver is adapted to phase-lock the LO signal to the QI signal.

5. The invention of claim 1, wherein:
the first optical source comprises a first optical-frequency comb source (OFCS) adapted to generate a first plurality of uniformly spaced frequency components;
the first optical modulator is adapted to independently modulate each frequency component from the first plurality to encode quantum bits and provide a basis set selection for the transmitter; and
the QI signal comprises at least a subset of the modulated frequency components from the first plurality.

6. The invention of claim 5, wherein:
the second optical source comprises a second OFCS adapted to generate a second plurality of uniformly spaced frequency components;
the second optical modulator is adapted to independently modulate each frequency component from the second plurality to provide a basis set selection for the receiver; and
the LO signal comprises at least a subset of the modulated frequency components from the second plurality.

7. The invention of claim 6, wherein the modulated frequency components from the first plurality and the modulated frequency components from the second plurality have a common set of frequencies.

8. The invention of claim 7, wherein:
the system comprises an optical coupler adapted to produce first and second interference signals by combining the LO signal with the QI signal; and
the receiver comprises a multi-channel homodyne detector adapted to process the interference signals, wherein:
for each frequency from the common set, the homodyne detector is adapted to measure an intensity difference between the first and second interference signals and apply a measurement result to a signal processor; and
the signal processor is adapted to generate a quantum key based on the measurement results.

9. The invention of claim 8, wherein, for each frequency from the common set, the signal processor is adapted to:
in each time slot, accept or reject a corresponding measurement result based on a comparison of the basis sets selected by the transmitter and the receiver for said time slot; and
compile the quantum key based on the accepted results.

10. The invention of claim 6, wherein each of the first and second optical modulators comprises:
a multiplexer/de-multiplexer (MUX/DMUX) adapted to de-multiplex the frequency components received from the corresponding OFCS; and
a MEMS array of movable mirrors, wherein:
each mirror in the array is adapted to receive a de-multiplexed frequency component, wherein position of the mirror with respect to a reference position determines a phase shift for said frequency component; and
the MUX/DMUX is further adapted to multiplex the phase-shifted frequency components to produce the corresponding QI or LO signal.

11. In a communication system for transmission of quantum information, a transmitter comprising a first optical source coupled to a first optical modulator, wherein the first optical modulator is adapted to modulate light generated by the first optical source to produce a quantum-information (QI) signal, wherein:
the communication system comprises a receiver coupled to the transmitter via a transmission link;
the QI signal is applied to the transmission link; and
the receiver comprises a second optical source coupled to a second optical modulator, wherein:
the second optical modulator is adapted to modulate light generated by the second optical source to produce a local-oscillator (LO) signal; and
the LO signal is combined with the QI signal received via the transmission link to ascertain quantum information carried by the QI signal.

12. The invention of claim 11, wherein the LO signal is not transmitted via the transmission link.

13. The invention of claim 11, wherein each of the first and second optical sources is referenced to a frequency standard.

14. The invention of claim 11, wherein the receiver is adapted to phase-lock the LO signal to the QI signal.

15. The invention of claim 11, wherein:
the first optical source comprises a first optical-frequency comb source (OFCS) adapted to generate a first plurality of uniformly spaced frequency components;
the first optical modulator is adapted to independently modulate each frequency component from the first plurality to encode quantum bits and provide a basis set selection for the transmitter; and
the QI signal comprises at least a subset of the modulated frequency components from the first plurality.

16. In a communication system for transmission of quantum information, a receiver comprising a second optical source coupled to a second optical modulator, wherein:
the second optical modulator is adapted to modulate light generated by the second optical source to produce a local-oscillator (LO) signal;
the communication system comprises a transmitter coupled to the receiver via a transmission link;
the transmitter comprises a first optical source coupled to a first optical modulator, wherein the first optical modulator is adapted to modulate light generated by the first optical source to produce a quantum-information (QI) signal applied to the transmission link; and
the LO signal is combined with the QI signal received via the transmission link by the receiver to ascertain quantum information carried by the QI signal.

17. The invention of claim 16, wherein:
the LO signal is not transmitted via the transmission link; and
the receiver is adapted to phase-lock the LO signal to the QI signal.

18. The invention of claim 16, wherein each of the first and second optical sources is referenced to a frequency standard.

19. The invention of claim 16, wherein:
the second optical source comprises a second OFCS adapted to generate a second plurality of uniformly spaced frequency components;
the second optical modulator is adapted to independently modulate each frequency component from the second plurality to provide a basis set selection for the receiver; and
the LO signal comprises at least a subset of the modulated frequency components from the second plurality.

20. A method of transmitting quantum information, comprising:
modulating light generated by a first optical source to produce a quantum-information (QI) signal at a transmitter of a communication system;
directing the QI signal via a transmission link to a receiver of said communication system;
modulating light generated by a second optical source to produce a local-oscillator (LO) signal at the receiver; and
combining the LO signal with the QI signal received via the transmission link at the receiver to ascertain quantum information carried by the QI signal.
